(19) United States
(12) Patent Application Publication
(10) Pub. No.: US 2026/0124102 A1
(43) Pub. Date: May 7, 2026

(54) ROLLER MASSAGER AND A MATCHED STORAGE BOX

(71) Applicant: LiShui RiFeng Electrical Appliance Co., Ltd., Lishui (CN)

(72) Inventor: Weifeng ZHOU, Lishui (CN)

(21) Appl. No.: 19/027,571

(22) Filed: Jan. 17, 2025

Related U.S. Application Data
(63) Continuation of application No. PCT/CN2024/129601, filed on Nov. 4, 2024.

(51) Int. Cl. A61H 15/00

(52) U.S. Cl. CPC A61H 15/0085; A61H 2015/0014; A61H 2201/0107; A61H 2201/1638; A61H 2201/1695

(57) ABSTRACT

The present disclosure claims a roller massager and a matched storage box. The roller massager comprises a rolling massage assembly; a bracket assembly rotatably connected with the rolling massage assembly, and a first handle and a second handle detachably connected at both ends of the bracket assembly; the bracket assembly comprises a first end base and a second end base, and an end base connecting pipe passing through the inside of the rolling massage assembly; both ends of the end base connecting pipe are fixedly connected with the first end base and the second end base respectively. A motor for driving the rolling massage assembly to rotate is arranged in the first handle, and a battery for supplying power to the motor is arranged in the second handle. The handles are detachable. The first handle and the second handle are fixed after being connected with the bracket assembly.

### CROSS-REFERENCE TO RELATED APPLICATIONS

This application is a continuation of International Patent Application No. PCT/CN2024/129601, filed on Nov. 4, 2024. The content of the aforementioned applications, including any intervening amendments thereto, are incorporated herein by reference.

### TECHNICAL FIELD

The disclosure belongs to the field of massage device, and in particular relates to a hand-held roller massager.

### BACKGROUND

Chinese Patent No. CN218338690U discloses a ball massager, which mainly comprises a ball mechanism for rolling massage, a driving mechanism and a follow-up mechanism connected to both sides of the ball mechanism. The driving mechanism is provided with a rotating motor that drives the ball mechanism to rotate, and the follow-up mechanism only serves as an auxiliary handle, which can rotate at will relative to the ball mechanism and the driving mechanism. The disadvantage is that when it is used for massage, the driving mechanism must be held, and it cannot work if only the follow-up mechanism is held alone. In other words, when the ball mechanism is squeezed to the massage position and rotates, only the force of one hand can resist the rotary force of the driving mechanism, which provides poor user experience.

Chinese patent CN308065631S discloses a roller massager of another structure, and the main difference from the CN218338690U is that a connecting rod is arranged between the left and right handles, so that the left and right handles are connected as a whole. For massage, two hands hold the two handles, and both hands can resist rotary force, which saves effort for users. However, there is still a disadvantage that the connecting rod is located at one side of the ball mechanism, so that a gap is formed between the ball mechanism and the connecting rod, which may cause the user's clothes to be caught in or the user to be accidentally pinched. Therefore, there is still room for further improvement of this type of rolling massage machine.

### SUMMARY

The technical problem to be solved by the present disclosure is as follows: in view of the shortcomings existing in the prior art, a roller massager that is convenient for disassembly and assembly, comfortable and labor-saving for holding during massage, small in storage volume and easy to carry is provided, and a storage box matched with it is also provided.

In order to achieve the purpose of the present disclosure, the following technical solution is adopted: A roller massager, comprising a rolling massage assembly; a bracket assembly rotatably connected with the rolling massage assembly, and a first handle and a second handle detachably connected at both ends of the bracket assembly; the rolling massage assembly and the bracket assembly constitute the main body of the massager; a motor for driving the rolling massage assembly to rotate is arranged in the first handle, and a battery for supplying power to the motor is arranged in the second handle; the first handle comprises a tubular first handle shell, one end of the first handle shell is a plug connector detachably connected with the bracket assembly, and a multi-functional bracket for reinforcing a transition position between the first handle shell and the plug connector is inserted in the first handle shell at a connection position with the plug connector; the motor is connected to one end of the multi-functional bracket away from the plug connector, and an electrical socket is also installed on the extension part.

A set of socket slots are arranged on the side wall of the multi-functional bracket, and an electrical socket is installed in the socket slot, and the electrical socket is electrically connected with the motor through conductor wires;

After the multi-functional bracket is inserted into the plug connector, the plug connector limits the electrical socket in the socket slot, and an opening for the electrical plug to pass through is provided on the plug connector at a position corresponding to the electrical socket.

Two buckle slots are formed on the side wall of the multi-functional bracket located at the plug connector, an elastic buckle is arranged in each buckle slot, and a through hole for the elastic buckle to pass through is formed on the side wall of the plug connector corresponding to the buckle slot;

The first end cap is provided with two clamping slots respectively engaged with the elastic buckles, and two buttons that respectively drive the two elastic buckles to disengage from the corresponding clamping slots are arranged on the first end cap.

The present disclosure further provides a storage box matched with the roller massager, comprising a storage seat and a storage cover detachably connected to the storage seat;

A massage assembly slot and an end cap locating slot located at both ends of the massage assembly slot are arranged on the storage seat, and two handle slots are arranged on the storage seat, not at the massage assembly slot and the end cap locating slot;

The storage box has a first state for accommodating a roller massager and a second state as a massager stand;

When the storage box is in the first state, the massager body is placed in the two end cap locating slots and the massage assembly slots, and the first handle and the second handle are respectively placed in the two handle slots; after the storage cover is connected with the storage seat, the storage cover presses and fixes the massager body, the first handle and the second handle on the storage seat;

When the storage box is in the second state, the first handle and the second handle are connected to both ends of the massager body, the first end cap, the second end cap and the two end cap locating slots of the massager are fixed by friction or a positioning structure, and the roller massager and the storage seat form a hand-free fixed massager.

Compared with the prior art, the beneficial effects of the disclosure are as follows: Since the first handle and the second handle are detachably connected to the bracket assembly, the massager body composed of the split bracket assembly and rolling massage assembly is short, for easy storage and carrying.

In addition, the multi-functional bracket is used for the installation of the motor, the electrical socket and the elastic buckle. Especially, the electrical socket and the elastic buckle can be fixed after the multi-functional bracket is installed into the first handle shell, which simplifies the installation steps. At the same time, the multi-functional bracket is just located at the front position of the plug connector and the first handle shell, which bears a large bending moment when the roller massager is held in hand. The installation position of the multi-functional bracket is just enough to effectively increase the overall strength of the first handle.

### BRIEF DESCRIPTION OF DRAWINGS

FIG. 1 is a structure diagram of the present invention when used as a hand massager.

FIG. 2 is a structure diagram of the first handle and the second handle when they are disassembled according to the present invention.

FIG. 3 is a schematic structural view of assembling the bracket assembly and the rolling massage assembly according to the present invention.

FIG. 4 is a connection structure diagram of the rolling massage assembly according to the present invention.

FIG. 5 is a connection structure diagram of the bracket assembly according to the present invention.

FIG. 6 is a schematic sectional view of the first end base according to the present invention.

FIG. 7 is a structure diagram of the first end cap according to the present invention.

FIG. 8 is a schematic sectional view of the first handle according to the present invention.

FIG. 9 is an exploded view of the first handle according to the present invention.

FIG. 10 is an exploded view of the second handle according to the present invention.

FIG. 11 is a schematic view of the roller massager when it is fixed on the storage seat for use according to the present invention.

FIG. 12 is a schematic view of the roller massager when it is disassembled and stored in the storage seat according to the present invention.

FIG. 13 is an exploded view of the storage box according to the present invention.

FIG. 14 is a connection structure diagram of the storage box according to the present invention.

FIG. 15 is a structure diagram of the inner sliding latch according to the present invention.

FIG. 16 is a structure diagram of the fixed massage seat according to the present invention.

### DETAILED DESCRIPTION OF THE EMBODIMENTS

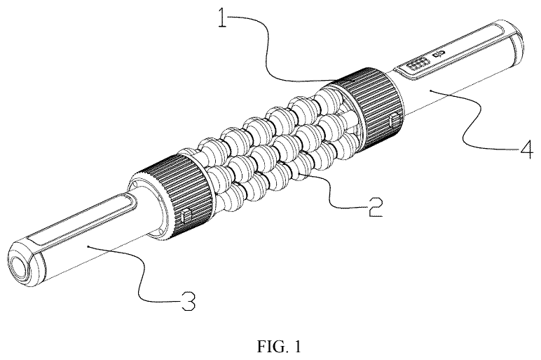

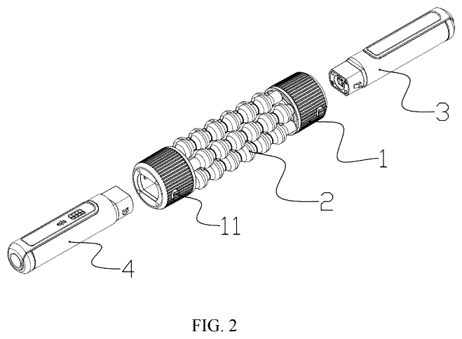

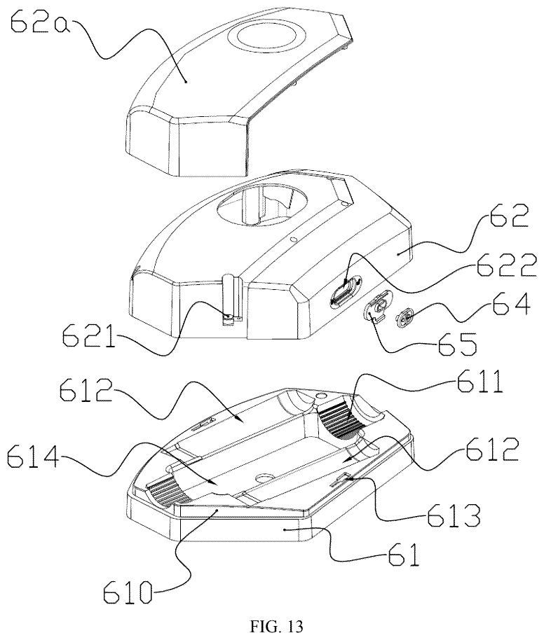

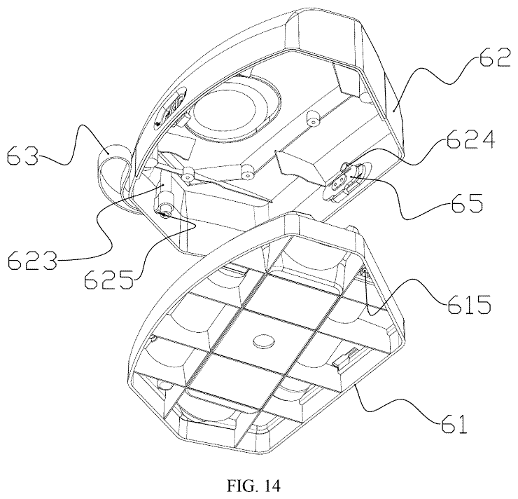

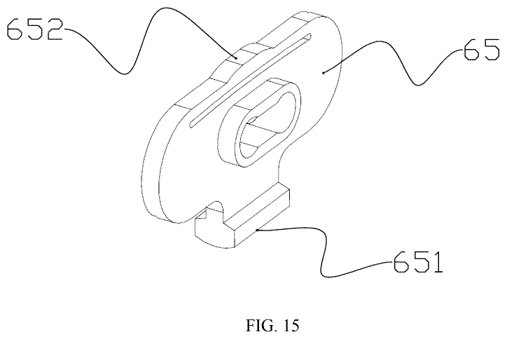

As shown in FIG. 1 to FIG. 16, the embodiment is a roller massager, comprising a rolling massage assembly 2, a bracket assembly 1 rotatably connected with the rolling massage assembly, and a first handle 3 and a second handle 4 detachably connected at both ends of the bracket assembly.

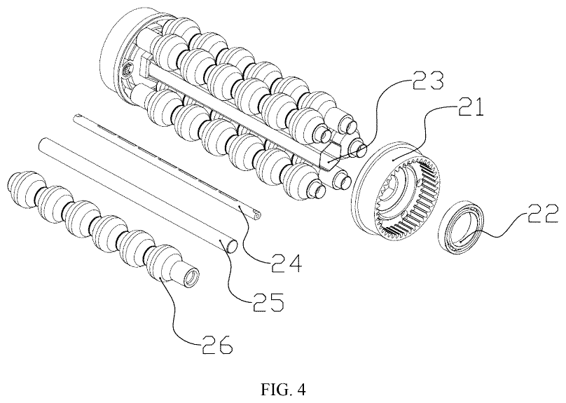

As shown in FIG. 4, the rolling massage assembly comprises two symmetrically arranged massage end bases 21, a polygonal tube 23 connected between the middle positions of the two massage end bases, a plurality of connecting rods 24 connected between the two massage end bases, and massage rollers 26 rotatably sleeved on each connecting rod. In this embodiment, the massage roller 26 is composed of a plurality of massage balls rotatably sleeved on the connecting rod 24, so that it not only facilitates the manufacturing of massage balls, but also two or more massage balls of different colors can be mounted on the rolling massage assembly to obtain rich appearance color; the connecting rod is a metal rod or a metal tube 25 is sleeved on the outer wall of the connecting rod. In other embodiments, the massage roller can also be an integrally injection molded tube body with multiple protruding massage parts along the length direction, i.e. similar to a plurality of closely arranged massaging balls in appearance.

The bracket assembly 1 comprises a first end base 12a and a second end base 12b located on the left and right sides of the rolling massage assembly, and an end base connecting pipe 10 passing through the inside of the rolling massage assembly. Both ends of the end base connecting pipe are fixedly connected with the first end base and the second end base respectively, so that when the first handle and the second handle are connected to the bracket assembly, the first handle and the second handle are fixed. The rolling massage assembly and the bracket assembly constitute the main body of the massager.

A motor 33 for driving the rolling massage assembly to rotate is arranged in the first handle, and the motor is a reduction motor with a built-in planetary reduction gear set; a battery 44 for supplying power to the motor is arranged in the second handle. It further comprises a conductor wire for electrically connecting the battery and the motor, wherein the conductor wire passes through the end base connecting pipe 10;

When the hand-held roller massager is used for massaging, the rolling massage assembly squeezes the muscles, and when the motor rotates, the bracket assembly will be subjected to a torque force in an opposite direction of the rotation direction of the rolling massage assembly. Since the first handle and the second handle are connected by the bracket assembly into a fixed whole, the first handle and the second handle can equally share the torque force transmitted from the bracket assembly, so that when the user holds the first handle and the second handle with both hands respectively for massaging, both hands are evenly stressed and comfortable.

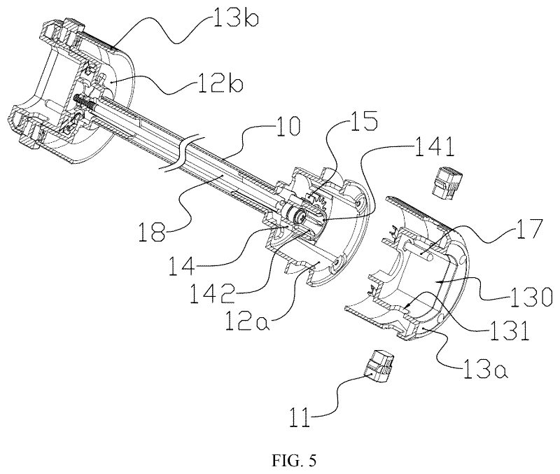

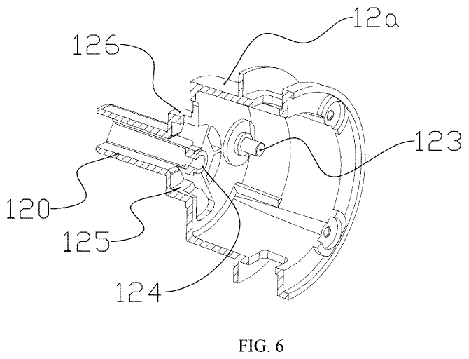

As shown in FIGS. 5 and 6, the end base connecting pipe 10 is a metal pipe with non-circular end faces. In this embodiment, the end base connecting pipe is a hexagonal stainless steel pipe; the first end base 12a and the second end base 12b are respectively provided with pipe joints 120 which are inserted into or sleeved with ends of the end base connecting pipe 10; after the first end base and the second end base are connected with both ends of the end base connecting pipe, the second end base is circumferentially fixed relative to the first end base; a tightening screw 18 and a tightening nut in threaded connection with the tightening screw are also connected between the first end base 12a and the second end base 12b, and the tightening screw passes through the inside of the end base connecting pipe; after the tightening nut is tightened with the tightening screw, the first end base, the end base connecting pipe and the second end base are relatively fixed in the axial direction.

The bracket assembly does not interfere with the rotation of the rolling massage assembly by improving the connection mode between the end base connecting pipe and the first and second end bases, thus avoiding winding and pinching caused by the external placement of the end base connecting pipe, and facilitating the arrangement of wires between the motor and the battery.

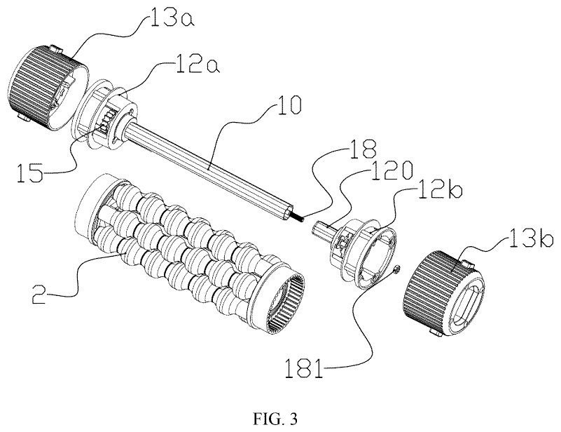

As shown in FIG. 3 and FIG. 5, one end of the rolling massage assembly is provided with an internal gear 211, more than 2 planetary gears 15 meshed with and in transmission connection with the internal gear are arranged on the first end base, a drive gear 14 meshed with and in transmission connection with each planetary gear is arranged on the first end base, and the drive gear is rotatably connected to the tightening screw 18 through a bearing.

Specifically, the two massage end bases on both sides of the rolling massage assembly are of exactly the same structure and are provided with the inner gear 211 on the outer inner circumference. In this way, it is not necessary to distinguish the left and right ends of the rolling massage assembly when connecting the rolling massage assembly with the bracket assembly, and it is easy for manufacturing since the two massage end bases have the same structure. As shown in FIG. 6, there are two notches on the first end base where the planetary gear 15 is installed, so that the planetary gear is meshed with and in transmission connection with internal gear 211.

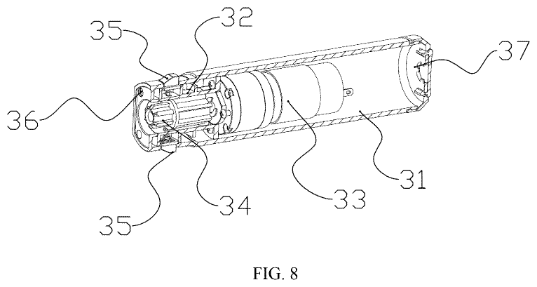

As shown in FIG. 5 and FIG. 8, the rear end of the drive gear is provided with a transmission sleeve 141, and the inner wall of the transmission sleeve is provided with transmission teeth 142 at equal angle along the circumferential direction; the output shaft of the motor is coaxially connected with a drive plug 34, and the outer wall of the drive plug is provided with drive teeth at equal angle along the circumferential direction; the first end base is also connected with a first end cap 13a, and the outer side of the first end cap is provided with a handle connecting sleeve 130 that is inserted with the first handle. After the first handle is inserted into the handle connecting sleeve on the first end cap, the transmission sleeve is in coaxial transmission plug-in connection with the drive plug; the ends of the drive teeth and the transmission teeth are both provided with inclined guide surfaces; the guide surface enables the drive teeth to rotate along with the drive gear through the guide surface, so that the drive teeth can be inserted between the adjacent transmission teeth, finally the drive plug can drive the drive gear to rotate synchronously.

Each end of the drive gear 14 is provided with a bearing. After passing through the two bearings on the drive gear, the tightening screw 18 passes through the screw base on the first end base 12a, the end base connecting pipe and the screw base on the second end base 12b in turn, then the tightening nut is connected to the tightening screw, and the tightening nut is tightened until it presses against the screw base on the second end base. That is, the first end base, the second end base and the end base connecting pipe are fixed, and the drive gear is fixed simultaneously by the tightening screw.

As shown in FIG. 6, the second end base 12b is connected with a second end cap 13b, and a handle connecting sleeve 130 to be plugged into the second handle is arranged on the second end cap, and a group of electrical plugs 17 are respectively installed at inner bottoms of the handle connecting sleeves of the first end cap and the second end cap; there are two electrical plugs in a group; two groups of electric plugs are electrically connected through a flexible wire.

A stud is arranged at the tail of the electrical plug, the inner bottom of the handle connecting sleeve is provided with a fixing hole for the stud to pass through, and a nut for fixing the electrical plug at the inner bottom of the handle connecting sleeve is connected with the stud; the end of the conductor wire is connected with an electrode plate, and the electrode plate is clamped between the nut and the handle connecting sleeve. The bottom of the first end cap is provided with two wire baffles 133, which separate the electrode plate and the conductor wire from the drive gear to avoid accidents such as damage or short circuit caused by friction or twisting between the conductor wire and the drive gear.

As shown in FIG. 6, the first end base 12a is integrally formed by metal, e.g. casted by aluminum alloy or stainless steel. The first end base is generally in the shape of a circular trough body, the inner bottom of the first end base is provided with a planetary gear shaft 123, and the planetary gear 15 is mounted on the planetary gear shaft through a bearing; a gap is arranged on the side of the first end base at a position corresponding to the planetary gear, and the gap provides a space for the planetary gear to engage with the internal gear.

The outer bottom of the first end base 12a is provided with a bearing insertion part 126 and the pipe joint 120 in order. A rolling bearing 22 is installed on the inner circumference of the massage end base, and the inner ring of the rolling bearing 22 is sleeved on the bearing insertion part 126. A screw seat 124 is arranged in the middle of the inner bottom of the first end base 12a, and a threading channel 125 for the conductor wire to pass through is formed on the first end base, which is located inside the bearing insertion part and on an outer periphery of the screw seat. The conductor wire is threaded into the pipe joint 120 and the end base connecting pipe 10 in sequence from the threading channel.

An annular space is formed between the outer wall of the handle connecting sleeve 130 and the inner wall of the first end cap 123a, and the first end base 12a is inserted into the annular space and fixedly connected with the first end cap by screws; after the first end cover and the first end base are connected in place, an outer wall of the handle connecting sleeve abuts against an inner wall of the first end base. In this embodiment, the first end cap is integrally molded with plastic, and an outer wall of the handle connecting sleeve abuts against an inner wall of the first end base, so that the handle connecting sleeve can bear a large force without bending after being connected to the first handle.

The second end base 12b has the same structure as that of the first end base 12a; a central through-hole 134 is arranged in the middle of the first end cap for passing through the transmission sleeve 141. Except that the second end cap 13b is not provided with a through hole, the rest of the structure is the same as that of the first end cap 13a.

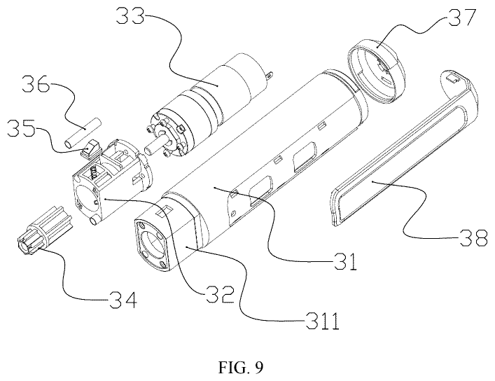

As shown in FIG. 8 and FIG. 9, the first handle comprises a tubular first handle shell 31; one end of the first handle shell is connected with the first handle rear cover 37, and the other end is a plug connector 311 detachably connected to the bracket assembly; a multi-functional bracket 32 for reinforcing a transition position between the first handle shell and the plug connector is inserted in the first handle shell at a connection position with the plug connector; the motor is connected to one end of the multi-functional bracket away from the plug connector; a set of socket slots 321 are arranged on the side wall of the multi-functional bracket, and an electrical socket 36 is installed in the socket slot, and the electrical socket is electrically connected with the motor through conductor wires; after the multi-functional bracket is inserted into the plug connector, the plug connector limits the electrical socket in the socket slot, and an opening for the electrical plug to pass through is provided on the plug connector at a position corresponding to the electrical socket. After the plug connector is inserted into the handle connecting sleeve, the electrical socket 36 is connected with the corresponding electrical plug 17 to form an electrical connection, so that the wire is conducted.

Two buckle slots 322 are formed on the side wall of the multi-functional bracket located at the plug connector, an elastic buckle 35 is arranged in each buckle slot, and a through hole for the elastic buckle to pass through is formed on the side wall of the plug connector corresponding to the buckle slot. The elastic buckle comprises a buckle body and a spring arranged between the buckle body and the bottom of the buckle slot.

When installing the elastic buckle 35, install the elastic buckle and spring into the buckle slot, insert the multi-functional bracket from the rear end of the first handle shell into the plug connector, then, the outer end of the elastic buckle protrudes from the buckle through hole on the side wall of the plug connector.

The multi-functional bracket is used to fix the motor 33, and cooperates with the side wall of the plug connector to fix the electrical socket 36 and the elastic buckle 35. At the same time, when the multi-functional bracket is inserted into the front part of the first handle shell and the plug connector, it serves to reinforce the plug connector.

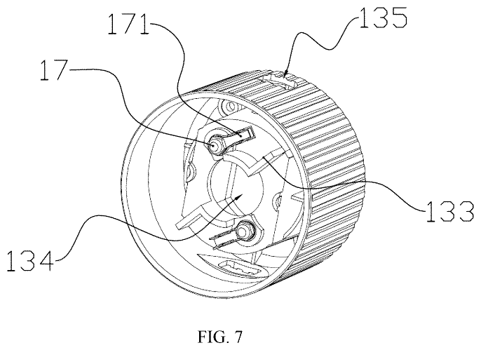

As shown in FIG. 6 and FIG. 7, the side wall of the handle connecting sleeve of the first end cap 13a is provided with a clamping slot 131 that is clamped to the two elastic buckles 35, the side wall of the first end cap is provided with a button limiting hole 135 at a position corresponding to the two clamping slots, and the side wall of the first end base is provided with a button through-hole 122 at a position corresponding to the clamping slot; an unlocking button 11 is slidably installed in each clamping slot, and when the unlocking button is pressed to the extreme position, the inner end of the unlocking button drives the elastic buckle at the corresponding position to disengage from the clamping slot; the plug connector can be pulled out of the handle connecting sleeve only when both the two elastic buckles are disengaged from the clamping slot at the corresponding position.

The same connection structure is used between the second handle and the second end cap. Since two relatively independent unlocking buttons are designed to unlock the two elastic buckles respectively, even if one of the unlocking buttons is accidentally touched, it will not cause the first handle or the second handle to be accidentally separated from the bracket assembly, resulting in damage to the massager or accidental injury to the user.

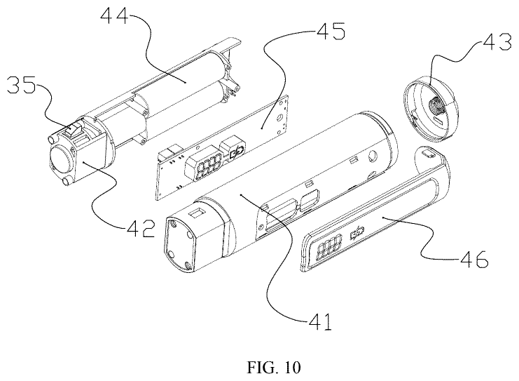

As shown in FIG. 10, the second handle comprises a tubular second handle shell 41, one end of the second handle shell is connected with a rear end cover 43, and the other end of the second handle shell is a plug connector detachably connected to the bracket assembly; a battery holder 42 is inserted into the second handle shell, and the battery and the control circuit board are fixed on the battery holder respectively; the battery holder extends into the plug connector, and a set of socket slots 321 are arranged on the side wall of the battery holder; an electrical socket 36 is installed in the socket slot, and the electrical socket and the storage battery are electrically connected with the control circuit board through conductor wires respectively; after the battery holder is inserted into the plug connector, the plug connector limits the electrical socket in the socket slot, and an opening for the electrical plug to pass through is provided on the plug connector at a position corresponding to the electrical socket.

The control circuit board is provided with a charging port and a power switch. In this embodiment, such a control circuit board generally has a charging module, a speed regulation module and a display device for displaying working parameters, which are all mature prior arts and not the focus of the present invention, so they will not be repeated here.

In addition, as shown in FIG. 9 and FIG. 10, a first decorative cover 38 is further connected to the outer wall of the first handle shell 31. The first decorative cover extends to an outer end of the rear cover of the first handle, that is, the first decorative cover is L-shaped as a whole. A second decorative cover 46 is connected to the outer wall of the second handle shell, and the shape of the second decorative cover is same as that of the first decorative cover. In this embodiment, as shown in FIG. 10, the display device faces a side wall of the second handle shell, an opening is formed at a position corresponding to the side wall of the second handle shell, and the second decorative cover is made of transparent material at least at a position corresponding to the opening.

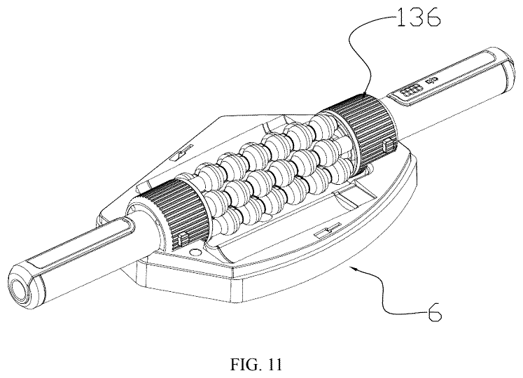

A storage box matched with the roller massager as shown in FIG. 11 to FIG. 15, comprising a storage seat 61 and a storage cover 62 detachably connected to the storage seat;

A massage assembly slot 614 and an end cap locating slot 611 located at both ends of the massage assembly slot are arranged on the storage seat, and two handle slots 612 are arranged on the storage seat, not at the massage assembly slot and the end cap locating slot; the storage box has a first state for accommodating a roller massager and a second state as a massager stand.

When the storage box is in the first state, the massager body is placed in the two end cap locating slots and the massage assembly slots, and the first handle and the second handle are respectively placed in the two handle slots; after the storage cover is connected with the storage seat, the storage cover presses and fixes the massager body, the first handle and the second handle on the storage seat.

When the storage box is in the second state, the first handle and the second handle are connected to both ends of the massager body, the first end cap, the second end cap and the two end cap locating slots of the massager are fixed by friction or a positioning structure, and the roller massager and the storage seat form a hand-free fixed massager.

In this embodiment, the first positioning teeth 136 are evenly arranged on the outer walls of the first end cap and the second end cap along the circumferential direction, the bottom shape of the end cap locating slot is adapted to the shape of the first end cap and the second end cap, and the second positioning teeth are evenly arranged at the bottom of the end cap locating slot. Therefore, after the massager body is placed on the storage seat, the first positioning tooth is matched with the second positioning tooth for positioning, so that the first end cap, the second end cap and the corresponding end cap locating slot are relatively fixed. The massage assembly slot is not in contact with the rolling massage assembly, that is, the rolling massage assembly can rotate relative to the storage seat.

The side wall of the storage cover is provided with more than two sliding latches, and the storage seat is provided with a latch connecting port 613 that matches and locks with the sliding latch;

The side wall of the storage cover is transversely provided with a latch mounting port 622 in a strip-shaped opening shape, and the sliding latch comprises an outer sliding latch 64 located outside the storage cover and an inner sliding latch 65 located inside the storage cover; the outer sliding latch passes through the latch mounting port to be fixedly connected with the inner sliding latch;

The latch connecting port has a wide mouth part and a narrow mouth part connected with each other, and the lower end of the inner sliding latch is provided with a locking part 652 whose width is smaller than that of the wide mouth part and larger than that of the narrow mouth part;

When the storage cover is placed on the storage seat, the locking part is inserted into the wide mouth of the latch connecting port at the corresponding position. When an external sliding latch is pushed along the latch mounting port, the locking part moves from the wide mouth to the narrow mouth so that the sliding latch and the latch connecting port are locked. The outer wall of the storage cover is provided with a sign indicating that the sliding latch is in a locked state or an unlocked state on both sides of the latch mounting port. The sign may be a text or a pattern.

A step 610 is formed on the periphery of an upper end of the storage seat 61, and a lower end of the storage cover is sleeved with the step; more than two lower positioning magnets 615 are arranged on the storage seat, and an upper positioning magnet 621 is arranged on the storage cover at a position corresponding to each lower positioning magnet.

The upper end of the inner sliding latch is integrally formed with an elastic locking part 652, and a transverse strip-shaped hole is arranged on the inner sliding latch below the elastic locking part, so that the elastic locking part can be deformed in the up-and-down direction; the inner wall of the storage cover is provided with a latch positioning column 624 which matches with the elastic locking part for positioning. When the sliding latch is in a locked state or an unlocked state, the elastic locking part is just located at one of the latch positioning columns. When the sliding latch switches between a locked state and an unlocked state, the elastic locking part 652 deforms and crosses over the latch positioning column.

The upper end of the storage cover is fixedly connected with a top cap 62a, and the upper positioning magnet 621 is clamped between the storage cover and the top cap.

The storage cover is connected with a flexible handle 63, the side wall of the storage cover is provided with a handle through hole 625, and a handle fixing rod 623 is arranged near the handle through hole in the storage cover; one end of the handle is sleeved on the handle fixing rod, and the other end passes out of the storage cover through the handle through hole.

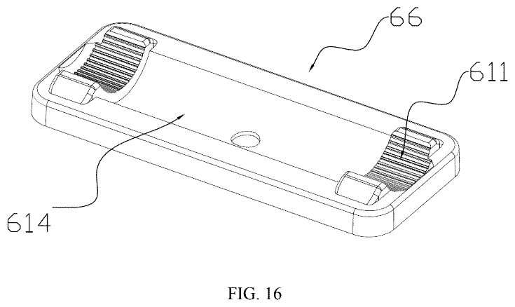

In other embodiments, the roller massager can be equipped with a fixed massage seat 66 as shown in FIG. 16. A massage assembly slot 614 and an end cap locating slot 611 located at both ends of the massage assembly slot are arranged on the storage seat. Compared with the storage box, the fixed massage seat is small in size and only for fixing the roller massager, not for storage.

In use, the first handle 3 is inserted into the handle connecting sleeve 130 of the first end cap 13a. When the elastic buckle 35 is inserted into the clamping slot 131, the elastic buckle will push the unlocking button 11 outwards, and it can be seen that the outer end of the unlocking button extends out of the outer wall of the first end base 12a. The second handle 4 is then inserted into the handle connecting sleeve of the second end cap 13b. Since the first handle is provided with a drive plug 34 which is matched and connected to the transmission sleeve 141 in the first end cap; the second handle has no drive plug and cannot be inserted into the second end cap, so there will be no problem that the first handle and the second handle are inserted in the wrong position.

After the first handle and the second handle are connected in place, it is only necessary to turn on the power switch, so that the motor 33 can transmit power to the inner gear 211 through the drive plug 34, the drive gear 14 and the planetary gear 15 in sequence, thus driving the whole rolling massage assembly 2 to rotate relative to the bracket assembly 1. At this time, any one or both of the first handle and the second handle can be held for rolling massage of muscles at various parts of the body.

For foot or leg muscle massage, as shown in FIG. 11, the first end cap 13a and the second end cap 13b are placed on the two end cap locating slots of the storage seat, then you can sit on a chair and step on the rolling massage assembly 2 for foot massage, or sit or lie down on a mat and lean your leg against the rolling massage assembly 2 for massage.

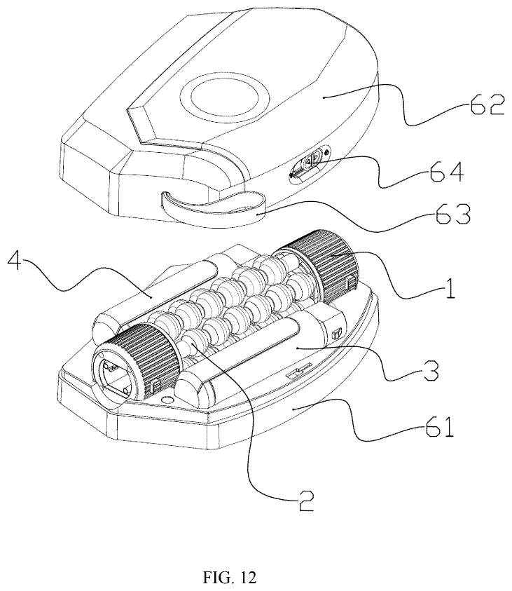

When the roller massager is not in use or needs to be carried out, the first handle and the second handle can be removed for easy storage. As shown in FIG. 12, the massager body and the two handles are placed into the corresponding storage slots on the storage seat, the storage cover is closed, and the sliding latch is locked with the latch connecting port.

In addition, the roller massager can be covered with a flexible cloth to reduce the friction between the massage roller and the massage position and improve comfort. Further, the cloth and the storage seat or the fixed massage seat can be detachably connected through magnets or buckles.

What is claimed is:

1. A roller massager, wherein comprising a rolling massage assembly (2), a bracket assembly (1) rotatably connected with the rolling massage assembly, and a first handle (3) and a second handle (4) detachably connected at both ends of the bracket assembly; the rolling massage assembly and the bracket assembly constitute the main body of the massager;
a motor (33) for driving the rolling massage assembly to rotate is arranged in the first handle, and a battery (44) for supplying power to the motor is arranged in the second handle;
the first handle comprises a tubular first handle shell (31), one end of the first handle shell is a plug connector (311) detachably connected with the bracket assembly, and a multi-functional bracket (32) for reinforcing a transition position between the first handle shell and the plug connector is inserted in the first handle shell at a connection position with the plug connector; and
the motor is connected to one end of the multi-functional bracket away from the plug connector, and an electrical socket is also installed on the extension part.

2. The roller massager according to claim 1, wherein a set of socket slots (321) are arranged on the side wall of the multi-functional bracket, and an electrical socket (36) is installed in the socket slot, and the electrical socket is electrically connected with the motor through conductor wires; and
after the multi-functional bracket is inserted into the plug connector, the plug connector limits the electrical socket in the socket slot, and an opening for the electrical plug to pass through is provided on the plug connector at a position corresponding to the electrical socket.

3. The roller massager according to claim 1, wherein two buckle slots (322) are formed on the side wall of the multi-functional bracket located at the plug connector, an elastic buckle (35) is arranged in each buckle slot, and a through hole for the elastic buckle to pass through is formed on the side wall of the plug connector corresponding to the buckle slot; and
the first end cap is provided with two clamping slots (131) respectively engaged with the elastic buckles, and two buttons that respectively drive the two elastic buckles to disengage from the corresponding clamping slots are arranged on the first end cap.

4. The roller massager according to claim 3, wherein the bracket assembly comprises a first end base (12a) and a second end base (12b) located on the left and right sides of the rolling massage assembly, and an end base connecting pipe (10) passing through the inside of the rolling massage assembly; both ends of the end base connecting pipe are fixedly connected with the first end base and the second end base respectively, so that when the first handle and the second handle are connected to the bracket assembly, the first handle and the second handle are fixed; and
a conductor wire for electrically connecting the battery and the motor, wherein the conductor wire passes through the end base connecting pipe.

5. The roller massager according to claim 4, wherein the end base connecting pipe (10) is a metal pipe with non-circular end faces, and the first end base (12a) and the second end base (12b) are respectively provided with pipe joints (120) which are inserted into or sleeved with ends of the end base connecting pipe (10); after the first end base and the second end base are connected with both ends of the end base connecting pipe, the second end base is circumferentially fixed relative to the first end base; and
a tightening screw (18) and a tightening nut in threaded connection with the tightening screw are also connected between the first end base (12a) and the second end base (12b), and the tightening screw passes through the inside of the end base connecting pipe; after the tightening nut is tightened with the tightening screw, the first end base, the end base connecting pipe and the second end base are relatively fixed in the axial direction.

6. The roller massager according to claim 5, wherein one end of the rolling massage assembly (2) is provided with an internal gear (211), more than 2 planetary gears (15) meshed with and in transmission connection with the internal gear are arranged on the first end base (12a), a drive gear (14) meshed with and in transmission connection with each planetary gear is arranged on the first end base, and the drive gear is rotatably connected to the tightening screw through a bearing.

7. The roller massager according to claim 6, wherein the rear end of the drive gear is provided with a transmission sleeve (141), and the inner wall of the transmission sleeve is provided with transmission teeth (142) at equal angle along the circumferential direction; the output shaft of the motor is coaxially connected with a drive plug (34), and the outer wall of the drive plug is provided with drive teeth at equal angle along the circumferential direction; and
the first end base is also connected with a first end cap (13a), and the outer side of the first end cap is provided with a handle connecting sleeve (130) that is inserted with the first handle; after the first handle is inserted into the handle connecting sleeve on the first end cap, the transmission sleeve is in coaxial transmission plug-in connection with the drive plug; the ends of the drive teeth and the transmission teeth are both provided with inclined guide surfaces.

8. The roller massager according to claim 7, wherein the second end base is connected with a second end cap (13b), and a handle connecting sleeve (130) to be plugged into the second handle is arranged on the second end cap, and a group of electrical plugs (17) are respectively installed at inner bottoms of the handle connecting sleeves of the first end cap and the second end cap; the two groups of electric plugs are electrically connected through a flexible wire.

9. The roller massager according to claim 8, wherein a stud is arranged at the tail of the electrical plug, the inner bottom of the handle connecting sleeve is provided with a fixing hole for the stud to pass through, and the stud is connected with a nut fixing the electrical plug at the inner bottom of the handle connecting sleeve; and
the end of the conductor wire is connected with an electrode plate, and the electrode plate is clamped between the nut and the handle connecting sleeve.

10. The roller massager according to claim 6, wherein the first end base (12a) is integrally formed by metal and generally in the shape of a circular trough body, the inner bottom of the first end base is provided with a planetary gear shaft (123), and the planetary gear (15) is mounted on the planetary gear shaft through a bearing; a gap is arranged on the side of the first end base at a position corresponding to the planetary gear, and the gap provides a space for the planetary gear to engage with the internal gear.

11. The roller massager according to claim 5, wherein the outer bottom of the first end base (12a) is provided with a bearing insertion part (126) and the pipe joint (120) in order, a screw seat (124) is arranged in the middle of the inner bottom of the first end base (12a), and a threading channel (125) for the conductor wire to pass through is formed on the first end base, which is located inside the bearing insertion part and on an outer periphery of the screw seat.

12. The roller massager according to claim 9, wherein an annular space is formed between the outer wall of the handle connecting sleeve (130) and the inner wall of the first end cap (123a), and the first end base (12a) is inserted into the annular space and fixedly connected with the first end cap by screws; after the first end cover and the first end base are connected in place, an outer wall of the handle connecting sleeve abuts against an inner wall of the first end base.

13. The roller massager according to claim 7, wherein the side wall of the handle connecting sleeve is provided with a clamping slot (131) which is engaged with two elastic buckles, the side wall of the first end cap is provided with a button limiting hole (135) at a position corresponding to the two clamping slots, and the side wall of the first end base is provided with a button through-hole (122) at a position corresponding to the clamping slot; an unlocking button (11) is slidably installed in each clamping slot, and when the unlocking button is pressed to the extreme position, the inner end of the unlocking button drives the elastic buckle at the corresponding position to disengage from the clamping slot; the plug connector can be pulled out of the handle connecting sleeve only when both the two elastic buckles are disengaged from the clamping slot at the corresponding position.

14. The roller massager according to claim 1, wherein the rolling massage assembly (2) comprises two symmetrically arranged massage end bases (21), a polygonal tube (23) connected between the middle positions of the two massage end bases, a plurality of connecting rods (24) connected between the two massage end bases, and massage rollers (26) rotatably sleeved on each connecting rod; the two massage end bases are rotatably connected with the bracket assembly through rolling bearings (22).

15. The roller massager according to claim 14, wherein the massage roller consists of a plurality of massage balls rotatably sleeved on the connecting rod, and the connecting rod is a metal rod or a metal tube (25) is sleeved on the outer wall of the connecting rod; and
alternatively, the massage roller is an integrally injection molded rod body, with a plurality of protruding massage parts along the length direction.

16. A storage box matched with the roller massager according to claim 1, wherein comprising a storage seat (61) and a storage cover (62) detachably connected with the storage seat;
a massage assembly slot (614) and an end cap locating slot (611) located at both ends of the massage assembly slot are arranged on the storage seat, and two handle slots (612) are arranged on the storage seat, not at the massage assembly slot and the end cap locating slot;
the storage box has a first state for accommodating a roller massager and a second state as a massager stand;
when the storage box is in the first state, the massager body is placed in the two end cap locating slots and the massage assembly slots, and the first handle and the second handle are respectively placed in the two handle slots; after the storage cover is connected with the storage seat, the storage cover presses and fixes the massager body, the first handle and the second handle on the storage seat; and
when the storage box is in the second state, the first handle and the second handle are connected to both ends of the massager body, the first end cap, the second end cap and the two end cap locating slots of the massager are fixed by friction or a positioning structure, and the roller massager and the storage seat form a hand-free fixed massager.

17. The storage box according to claim 16, wherein the side wall of the storage cover is provided with more than two sliding latches, and the storage seat is provided with a latch connecting port that matches and locks with the sliding latch;
the side wall of the storage cover is provided with a latch mounting port (622) in a strip-shaped opening shape, and the sliding latch comprises an outer sliding latch (64) located outside the storage cover and an inner sliding latch (65) located inside the storage cover; the outer sliding latch passes through the latch mounting port to be fixedly connected with the inner sliding latch;
the latch connecting port has a wide mouth part and a narrow mouth part connected with each other, and the lower end of the inner sliding latch is provided with a locking part (652) whose width is smaller than that of the wide mouth part and larger than that of the narrow mouth part; and
when the storage cover is placed on the storage seat, the locking part is inserted into the wide mouth of the latch connecting port at the corresponding position; when an external sliding latch is pushed along the latch mounting port, the locking part moves from the wide mouth to the narrow mouth so that the sliding latch and the latch connecting port are locked.
